(19) United States
(12) Patent Application Publication
(10) Pub. No.: US 2022/0088975 A1
(43) Pub. Date: Mar. 24, 2022

(54) TYRE COMPRISING A NOISE-REDUCING ELEMENT

(71) Applicant: Pirelli Tyre S.p.A., Milano (IT)

(72) Inventors: Raffaella DONETTI, Milano (IT); Ross LANDON, Milano (IT); Andrea SCOTTI, Milano (IT)

(73) Assignee: Pirelli Tyre S.p.A., Milano (IT)

(21) Appl. No.: 17/298,204

(22) PCT Filed: Dec. 2, 2019
(86) PCT No.: PCT/IT2019/050252

§ 371 Date: May 28, 2021

(30) Foreign Application Priority Data
Dec. 12, 2018 (IT) 102018000011001

(51) Int. Cl. B60C 19/00; B60C 11/04

(52) U.S. Cl. CPC B60C 19/002; B60C 11/04

(57) ABSTRACT

The present disclosure is directed to a tyre comprising a tread band having one or more reliefs with circumferential development, and a noise-reducing element applied on an inner surface of the tyre and extending along at least half of a circumferential development of the inner surface, wherein the noise-reducing element comprises a series of radially through openings, wherein the series of openings extends along the circumferential development of the inner surface and wherein the series of openings is placed so that at least half of an overall plant area of the openings of the series of openings is placed at one relief of the one or more reliefs.

### TECHNICAL FIELD OF THE INVENTION

The present invention relates to a tyre comprising a noise-reducing element applied on an inner surface of said tyre.

### STATE OF THE ART

Typically a tyre has a substantially toroidal structure abound an axis of rotation thereof during operation, and it has an equatorial plane perpendicular to the axis of rotation, said equatorial plane typically being a plane of (substantial) geometric symmetry (e.g. neglecting possibly minor asymmetries, such as the tread design and/or the writing on the sides and/or the inner structure).

With “tread band” it is meant the tyre portion radially outermost which comes into contact with the rolling surface, comprising a tread design, typically characterized by reliefs and by grooves.

With “crown portion” it is meant the tyre portion which is at the tread band.

With ‘inner surface’ it is meant the tyre surface not visible when the tyre is mounted on a respective rim.

With ‘inner cavity’ it is meant the space delimited by the inner surface of the tyre and by the surface of the rim that faces to the inner surface of the tyre, when mounted.

With ‘inner circumferential development’ it is meant the linear development of the inner surface of the tyre on its axial middle plane.

The terms “radial” and “axial” and the expressions “radially inner/outer” and “axially inner/outer” are used making reference to respectively a direction perpendicular to and a direction parallel to the axis of rotation of the tyre.

The terms ‘circumferential’ and ‘circumferentially’ are instead used making reference to the direction of the annular development of the tyre, i.e. the rolling direction of the tyre.

With ‘substantially perpendicular’ relatively to geometric elements (such as straight lines, planes, surfaces) it is meant that these elements (or elements parallel to them and incident to each other) form an angle of 90°+/−15°, preferably 90°+/−10°.

With ‘substantially parallel’, relatively to the aforesaid geometric elements, it is meant that these elements (or elements parallel to them and incident to each other) form an angle of 0°+/−15°, preferably 0°+/−10°.

With ‘substantially’ together with the terms ‘radial, axial, circumferential’, relatively to the aforesaid geometric elements it is meant that these elements (or elements parallel to them and incident to each other) form an angle of 0°+/−15°, preferably 0°+/−10°, respectively with the radial, axial and circumferential directions.

It is known applying a noise-reducing element to the inner surface of a tyre. With the expression “noise-reducing element” it is meant an element that, once applied on the inner surface of a tyre (typically on the portion of inner surface placed at the tread band), has the ability to attenuate the noise produced during the rolling due to the presence of the inner cavity (cavity noise). This ability is usually given to the aforesaid element by the type of material, or materials, with which said element is made and/or by the shape and/or by the sizes thereof. The noise-reducing element can be in single body (which typically develops substantially for most of the inner circumferential development), or it can consist of a plurality of noise-reducing sub-elements arranged in sequence along the inner circumferential development of the tyre. This element in single body or each noise-reducing sub-element may consist of a block, for example with substantially parallelepiped shape, made of foam material, for example a sound-absorbing material based on polymeric foams, which is glued to the portion of inner surface of the tyre placed at the tread band.

The documents EP1852279B1 and US20040066083 A1 disclose tyres comprising noise-reducing elements.

WO2017001997 discloses a tyre for vehicle wheels comprising at least one sound-absorbing layer fixed to a radially inner surface of the tyre at a tread band wherein the sound-absorbing layer delimits, together with the radially inner surface, a channel which extends along a circumferential direction.

US20120325383 A1 discloses an assembly for tyres comprising a core made of acoustic foam arranged inside the cavity of a tyre for attenuating the cavity noise. The foam core may include an annular base having a plurality of projections arranged on an outer face of the annular base for engaging the inner surface of the tyre and for spacing the annular base out from the inner surface of the tyre.

### SUMMARY OF THE INVENTION

In the context of high and very high performances tyres (i.e. tyres that allow to reach speeds over 200 km/h and up to over 300 km/h), the Applicant has observed that, during the use of the tyres, the crown portion undergoes a considerable thermal rise due to different factors, such as the deformations of the viscoelastic materials that make it up, the frictions, etc. The tread band at the reliefs of the tread design is particularly subjected to such heating due to the direct contact between the aforesaid reliefs and the rolling surface.

The localized temperature increase that characterizes this thermal rise can lead to the loss of structural integrity of the crown portion of the tyre, even up to the formation of holes (“blistering” phenomenon) at the tread band, due to the localized decomposition of the compound of the tyre subsequently removed due to the rotational movement of the latter and/or to the delamination of the tread, in particular of its central relief.

The Applicant has also observed that the noise-reducing element, typically applied along a main part of the inner surface of the tyre at the tread band for the purpose of the reduction of the cavity noise, can behave as a thermal resistance which hinders a correct dissipation, from the crown portion towards the inner cavity of the tyre, of the heat accumulated by the crown portion, causing a higher thermal rise with respect to the situation in absence of the noise-reducing element.

According to the Applicant the known solutions for the dissipation of the heat accumulated by the crown portion in presence of noise-reducing elements applied on the inner surface of a tyre for high and very high performances are improvable in some aspects.

For example, the Applicant has noted that a noise-reducing element of the type disclosed by US20120325383 A1 seems complex to be made, due to its particular conformation, and/or it seems complex to be applied on a tyre due to the reduced contact area with the inner surface of the tyre which makes the bonding difficult (so as to require a possible oversizing thereof and/or the presence of further rigid fixing elements inside the tyre cavity, with the consequent increase of weight and encumbrance). Furthermore, the noise-reducing element disclosed in US20120325383 A1, due to the presence of the projections which keep the element distant from the inner surface making a gap between element and inner surface, could be structurally weak since the gap would facilitate the onset of fatigue phenomena by deformation during the passage in footprint area.

The Applicant has therefore faced the problem of making a noise-reducing element able to limit the overheating of the crown portion, in particular of the tread band, and which is at the same time able to withstand the severe conditions of use of the high and very high performances tyres, maintaining over time the structural integrity and/or the noise reduction ability and/or the correct positioning.

The Applicant has found that providing the noise-reducing element with radially through openings suitably positioned with respect to the tread band, favours the effective dissipation of the heat accumulated by the crown portion, without compromising the structural integrity of the element itself and/or its noise reduction ability.

According to an aspect the invention relates to a tyre comprising a tread band having one or more reliefs with circumferential development, and a noise-reducing element applied on an inner surface of said tyre and extending along a prevalent portion of a circumferential development of the inner surface.

Preferably said noise-reducing element comprises a series of radially through openings.

Preferably said series of openings extends along said circumferential development of the inner surface.

Preferably said series of openings is placed so that at least a prevalent portion of an overall plant area of the openings of said series of openings is placed at one relief of said one or more reliefs.

With the expression ‘prevalent portion’ referred to a quantity it is meant at least half of that quantity.

The Applicant has found that the present invention allows to maintain the performance of the tyres comprising a noise-reducing element at the desired level, thanks to a better radial dissipation of the heat from the tread band towards the inner cavity, while ensuring the structural integrity of the noise-reducing element, even at very high speeds (e.g. above 300 km/h).

The present invention provides on the noise-reducing element (at least) one series of openings radially passing through the element itself, i.e. openings which continuously run from one side of the noise-reducing element facing the inner surface of the tyre to an opposite side of the element facing the inner cavity of the tyre. Therefore, each of these openings is delimited by a respective closed surface entirely belonging to said noise-reducing element.

The openings are prevalently placed at a relief, i.e. taken the development of the crown portion on a plane, at least a prevalent portion of the overall plant area of the openings is superimposed on the plant extension of the relief.

These openings not only favour the direct heat transfer between the inner surface and the inner cavity, but thanks to their positioning they also favour such heat transfer precisely at the regions of the crown portion subjected to higher overheating, i.e. the regions corresponding to the reliefs, thus increasing the dissipation efficiency being equal the ‘open’ surface, and thus maintaining the noise reduction function.

Infatti l'aria presente all'interno della cavita dello pneumatico può entrare (sostanzialmente) direttamente in contatto (e.g. escludendo un eventuale strato di adesivo interposto tra l'elemento riduttore di rumore e la superficie interna dello pneumatico anche in corrispondenza delle aperture) con le porzioni di superficie interna corrispondenti al rilievo favorendo la dissipazione radiale del calore, ad esempio per convezione. Ancora, le porzioni di superficie interna lasciate libere dalle aperture possono dissipare calore anche per irraggiamento.

In fact, the air inside the tyre cavity can (substantially) directly (e.g. excluding a possible adhesive layer interposed between the noise-reducing element and the inner surface of the tyre also at the openings) contact the portions of inner surface corresponding to the relief favouring the radial heat dissipation, for example by convection. Moreover, the portions of inner surface left free by the openings can dissipate heat also by irradiation.

Therefore, for a given value of the ratio between volume of the openings and full volume of the noise-reducing element (which affects the structural strength of the element itself and/or its noise reduction ability), the specific positioning of the openings at the reliefs optimizes the effectiveness of these empty spaces in terms of thermal dissipation.

It follows a moderation of the aforesaid phenomenon of thermal rise and an achievement of high levels of tyre performance (e.g. in terms of supported speed).

The present invention in one or more of the aforesaid aspects can have one or more of the following preferred features.

Preferably said tyre comprises an adhesive layer (e.g. a pressure sensitive adhesive) interposed between said noise reducing element and said inner surface (for fixing the element itself). This adhesive layer may, or may not, be present at the openings.

Preferably each of said one or more reliefs is (substantially, e.g. neglecting minor notches defining the tread design) circumferentially continuous.

Typically, each of said one or more reliefs has a development also along an axial direction.

Preferably said tread band comprises a plurality of grooves with circumferential development, more preferably circumferentially continuous.

Preferably at least one relief of said one or more reliefs (e.g. said relief) is defined by two of said grooves arranged adjacent to, and at opposite sides of, said at least one relief.

Preferably said relief is a relief arranged in an (substantially) axially central portion of the tread band, for example a central relief arranged in an axially central position of the tread band. Since the axially central portion of the tread band is the one typically subjected to higher overheating, the aforesaid positioning of the series of openings optimizes their effectiveness in terms of heat dissipation.

Preferably said noise-reducing element comprises a first face (substantially) entirely adjacent to, and in contact with, said inner surface of said tyre (except for the possible adhesive layer interposed between the element and the inner surface). In other words, there is no cavity between the element and the inner surface, so as to favour the adhesion.

Preferably said noise-reducing element comprises one or more further series of radially through openings, wherein each further series of openings extends along said circumferential development of the inner surface. In this way the heat transfer efficiency of the noise-reducing element is enhanced, which can be extended also to portions of the inner surface axially peripheral with respect to the equatorial plane.

Typically said tread brand comprises at least two reliefs, preferably at least three reliefs, with (continuous) circumferential development, said reliefs being axially distributed.

Preferably at least one, more preferably each, of said one or more further series of openings is placed so that at least a prevalent portion of an overall plant area of the openings of said at least one (or of each) further series of openings is placed at one respective further relief of said one or more reliefs (in addition to said relief). In this way the heat transfer efficiency of the further series of openings is optimized, which is achieved also at regions of the inner surface of the tyre placed at further reliefs of the tread band in addition to the aforesaid relief (e.g. further reliefs axially placed beside the axially central relief).

Preferably said series of openings and said one or more further series of openings are arranged side by side along an axial dimension of said tyre.

Preferably said noise-reducing element comprises at least two further series of radially through openings, more preferably arranged at axially opposite sides of said series of openings. In this way the openings are arranged in optimal way with respect to the tread band having at least three reliefs.

Preferably said noise-reducing element extends along (substantially) the whole circumferential development of the inner surface, for example at least 70%, more preferably at least 80%, of the circumferential development of the inner surface.

Preferably the openings of said series of openings, and/or the openings of each of said one or more further series of openings, are arranged, more preferably in (substantially) regular manner, along (substantially) the whole circumferential development of said inner surface. In this way the heat transfer ability is made circumferentially uniform, for limiting every local overheating of the tyre.

Preferably said prevalent portion of overall plant area of the openings of said series of openings, and/or of the openings of said at least one (or of each) further series of openings is greater than or equal to 60%, more preferably greater than or equal to 70%, even more preferably greater than or equal to 80% or equal to 100%, of said overall plant area. In this way the openings are adequately exploited optimizing their heat transfer efficiency.

Preferably a ratio between an overall volume of all the openings present on the element, and an overall volume of the noise-reducing element, is greater than or equal to 0.1, more preferably greater than or equal to 0.15, and/or less than or equal to 0.4, more preferably less than or equal to 0.35. In this way the noise-reducing element is optimized for the facilitation of the heat transfer and at the same time for the reduction of the cavity noise, while maintaining an appropriate structural resistance.

Preferably said series of openings comprises openings having the same shape and/or dimensions. Preferably each further series of openings comprises openings having the same shape and/or dimensions. Preferably all the further series of openings comprise the same number of openings. Preferably the openings of all the further series of openings have the same shape and/or dimensions and/or circumferential arrangement.

In this way the effect of the openings is uniform and the design and/or the construction of the noise-reducing element is simplified.

Preferably a boundary surface of each opening has (substantially) radial development. In this way, with the same thickness of the noise-reducing element, the heat transfer is facilitated for.

Preferably a section of each opening perpendicular to an axis of development of said opening is constant along said axis of development. In this way the heat transfer is optimized, without compromising the mechanical resistance of the noise-reducing element.

In one embodiment each opening of said series of openings, and/or each opening of one or more of said one or more further series of openings, has section perpendicular to an axis of development thereof of circular shape having a diameter.

Preferably said diameter is greater than or equal to 2 cm and/or less than or equal to 6 cm, more preferably less than or equal to 5 cm. In this way the openings are sufficiently large to favour the heat transfer without compromising at the same time, given the size of the noise-reducing element or of the noise-reducing sub-elements typically used, the integrity of the noise-reducing element.

In one embodiment each opening of said series of openings, and/or each opening of one or more of said one or more further series of openings, has section perpendicular to an axis of development thereof having an elongated shape with a main dimension. For example, the openings can have oval shape, rectangular shape, etc.

Preferably said main dimension of the openings is substantially parallel to said circumferential development. In this way each opening is substantially parallel to the circumferential development of the reliefs, with benefit to the heat dissipation efficiency.

Preferably said main dimension of each opening has a length greater than or equal to 5 cm and/or less than or equal to 15 cm. In this way the heat transfer of the inner surface of the tyre is favoured without compromising at the same time (given the sizes of the noise-reducing element or of the noise-reducing sub-elements typically used) the integrity of the noise-reducing element and without compromising the cavity noise attenuation.

Preferably said elongated shape comprises two end portions along said main dimension having a lobed shape and a central portion, of reduced size, which interconnects said two end portions. According to the Applicant this shape favours the heat transfer limiting the structural impairment and maintaining the noise reduction properties.

Preferably the openings of said series of openings, and/or the openings of said one or more further series of openings, are (substantially) axially aligned with each other. In other words, the centres of the openings of the same series substantially belong to a same plane perpendicular to the axis of the tyre. In this way the openings are centred with respect to the plant extension of the relief and/or of the respective further relief/s.

Preferably the openings are arranged onto said noise-reducing element according to an ordered scheme. In this way the arrangement of the series of openings is rational.

Preferably said ordered scheme comprises a base module repeated along said circumferential development, typically in substantially equispaced manner.

Preferably said base module has a first symmetry plane parallel to an equatorial plane of the tyre. Preferably said base module has a second symmetry plane perpendicular to an equatorial plane of the tyre. In this way the definition and repetition of the base module is rational.

Preferably said base module comprises a first set of openings belonging to said series of openings. Preferably a number of openings of said first set is greater than or equal to one, and/or less than or equal to three.

Preferably said base module comprises a second set of openings for each further series of openings. Preferably a number of openings of each second set it is greater than or equal to two, and/or less than or equal to four.

Preferably said noise-reducing element comprises a plurality of noise-reducing sub-elements applied circumferentially in sequence along said circumferential development of the inner surface of said tyre, more preferably spaced between each other, even more preferably (substantially) equidistant between each other (possibly except for a couple of sub-elements), typically axially aligned. In this way the application of the element to the tyre is facilitated, for example through automated procedures.

Preferably said noise-reducing element, and/or each noise-reducing sub-element, is (in the non-deformed configuration) a (typically rectangular, though not necessarily) parallelepiped. Preferably, said noise-reducing element, and/or each noise-reducing sub-element, has a rectangular shape in plant, preferably having a long side arranged according to said circumferential development and a short side according to an axial direction. In use the respective thickness is arranged radially.

Preferably said noise-reducing element comprises, more preferably it is entirely made of, a sound-absorbing material, preferably a polymeric foam, preferably expanded polyurethane, preferably with open cells.

Preferably the sound-absorbing material has a density ranging from about 5 kg/m³ to about 60 kg/m³.

Preferably all the sub-elements of said plurality of noise-reducing sub-elements have axial width equal between each other (said width being typically determined as a function of the axial width of the tyre). In this way the noise-reducing sub-elements effectively exert their action of noise reduction and dissipation of the heat accumulated by the crown portion.

Preferably said plurality of noise-reducing sub-elements comprises a number of noise-reducing sub-elements greater than or equal to five, more preferably greater than or equal to ten, and/or less than or equal to twenty-five, more preferably less than or equal to twenty. In this way it is possible to cover a given circumferential development of a tyre.

Preferably each noise-reducing sub-element comprises one, and preferably only one, base module. In this way the repetition of the base module is guaranteed by the circumferentially in sequence application of the sub-elements.

### BRIEF DESCRIPTION OF THE DRAWINGS

FIG. 1 shows a partial view of a plane development of a crown portion of a tyre according to the present invention, with some parts in transparency;

FIG. 2 shows a section along the equatorial plane A-A of the tyre of FIG. 1;

FIGS. from 3 to 7 respectively show a noise-reducing sub-element according to some embodiments of the present invention.

### DETAILED DESCRIPTION OF SOME EMBODIMENTS OF THE INVENTION

The features and the advantages of the present invention will be further clarified by the following detailed description of some embodiments, presented by way of example and not limitative of the present invention, with reference to the attached figures.

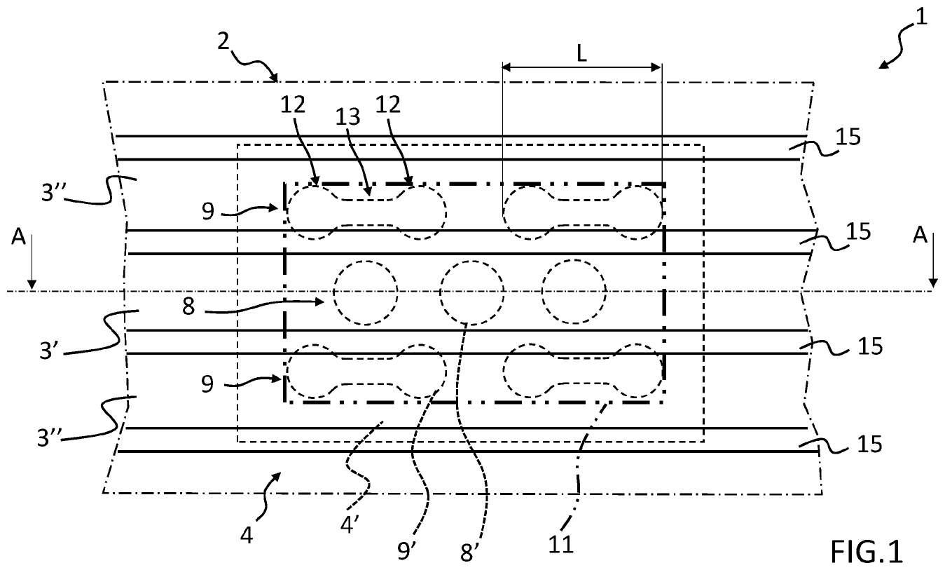

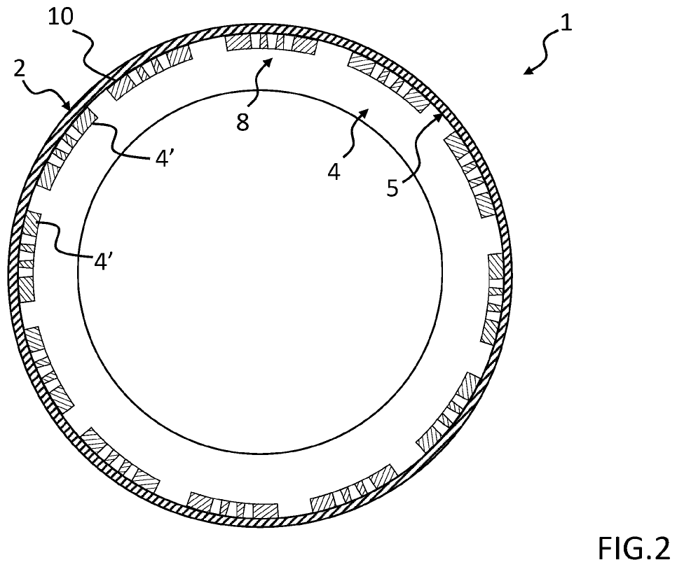

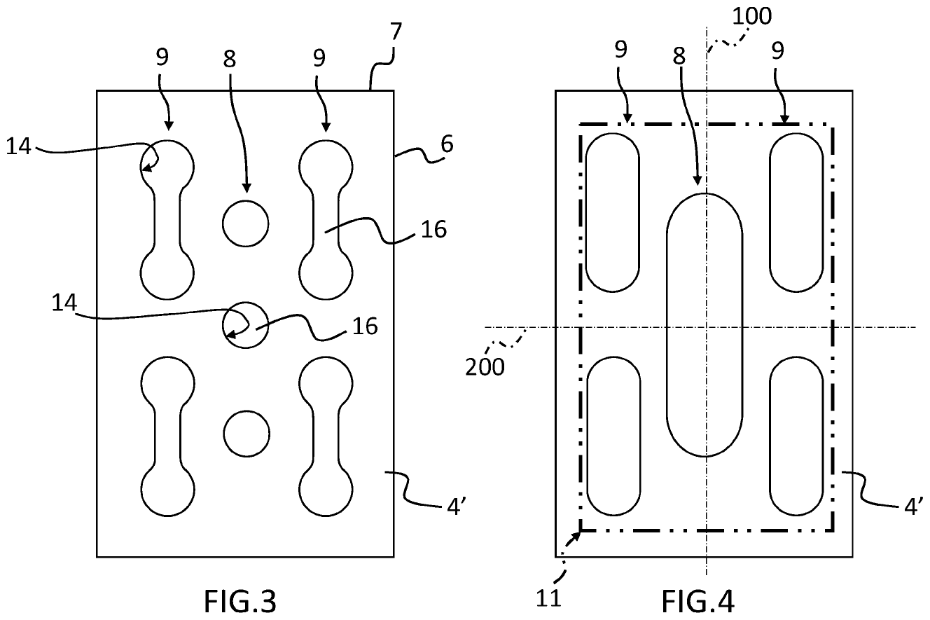

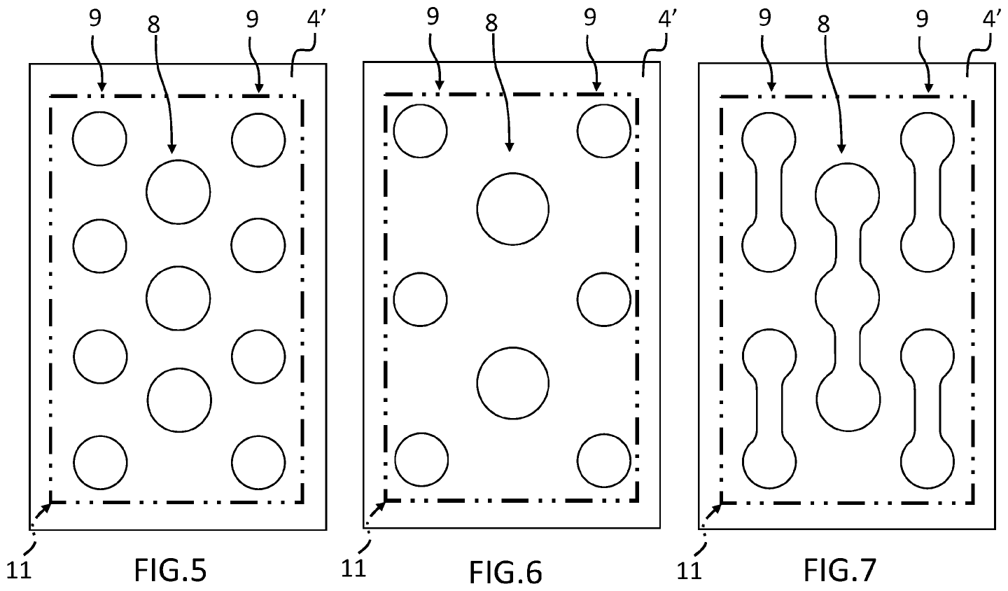

With reference to FIGS. 1 and 2, they show a tyre 1 (only partially shown in FIG. 1 and shown in section in FIG. 2) comprising a tread band 2 (only schematically shown) having, for purely illustrative purpose, at least three reliefs (partially shown in FIG. 1) with continuous circumferential development and axially distributed.

Exemplarily the reliefs comprise an axially central relief 3′, arranged in axially central position of the tread band, and two further reliefs 3″ axially arranged at the sides of the central relief. The central relief is defined (e.g. it is separated from the further reliefs) by a pair of grooves 15 with continuous circumferential development, arranged adjacent to, and at opposite side of, the central relief 3′. During the use of the tyre, it may occur that the relief of the tread band subjected to greater thermal rise is one of the two further reliefs (3″), due to the conditions of use of the tyre and/or the configuration of the vehicle.

Exemplarily the tyre 1 comprises a noise-reducing element 4 (FIG. 2) applied on an inner surface 5 of the tyre and extending along substantially the whole circumferential development of the inner surface 5.

Exemplarily the noise-reducing element 4 consists of a plurality (in the example twelve) of noise-reducing sub-elements 4′, having axial width (in the example also circumferential length) equal between each other, applied equidistant to each other and circumferentially in sequence along the whole circumferential development of the inner surface 5 of the tyre 1 (as shown in FIG. 2).

Exemplarily, each noise-reducing sub-element 4′ is, in the non-deformed configuration (shown in FIGS. from 3 to 7 and in the plane development of the crown portion of FIG. 1), a rectangular parallelepiped having a long side 6 arranged according to the circumferential development and a short side 7 arranged according to an axial direction (when the sub-element is applied to the tyre). In use the respective thickness is arranged radially.

Exemplarily each noise-reducing sub-element 4′ is entirely made of a sound-absorbing foam of expanded polyurethane with open cell, having a density of about 30 kg/m³. Each noise-reducing sub-element 4′ is applied on the inner surface of the tyre by a pressure sensitive adhesive layer (not shown) interposed between each sub-element and the inner surface itself.

Exemplarily each noise-reducing sub-element 4′ comprises a first face 10 (FIG. 2) entirely adjacent to, and in contact with, the inner surface 5 of the tyre 1, except for the aforementioned adhesive layer.

The noise-reducing element 4 comprises a series 8 of openings 8′ (entirely shown only in FIG. 2), arranged in axially central position, and two further series 9 of openings 9′ (only partially shown in FIGS. 1 and 3-7) arranged at axially opposite sides of the series 8 of openings.

Each opening of the series 8 and of the further series 9 is radially through and delimited by a respective boundary surface 14 having a radial development and entirely belonging to the noise-reducing element 4. Exemplarily the openings of the series 8 and of the further series 9 are axially aligned (with respect to a same series) and they have a respective section 16, perpendicular to an axis of development thereof (not shown, perpendicular to a lying plane of the openings), constant along the axis of development itself.

In one embodiment not shown, the boundary surface which delimits the openings may not be radial, for example it may have inclined cylinder shape.

The series 8 and the further series 9 of openings develop along the circumferential development of the inner surface 5 of the tyre. The openings of each series are arranged, in substantially regular way, along substantially the whole circumferential development of the inner surface (as shown for the series 8 in FIG. 2). The arrangement on the noise-reducing element of the openings of the series 8 and of the further series 9 follows an ordered scheme comprising a base module 11 repeated along the circumferential development, in substantially equispaced manner.

Exemplarily each noise-reducing sub-element 4′ comprises one and only one base module 11, the base module 11 comprising in turn a first set of openings belonging to the series 8 of openings and a pair of second sets of openings, each belonging to a respective further series 9 of openings. The series 8 and the further series 9 of openings are therefore made by the combination in sequence of the noise-reducing sub-elements 4′ along the inner circumferential development of the tyre 1.

Consequently, the openings made in the noise-reducing sub-elements shown in FIG. 1 and in FIGS. from 3 to 7 constitute, for each noise-reducing sub-element, a single base module 11 of the ordered scheme according to which the series 8 and the further series 9 of openings are arranged.

With reference to FIG. 1, which shows a noise-reducing sub-element applied on the inner surface of the tyre, the series 8 of openings (shown only by means of the base module 11) is exemplarily positioned so that an overall plant area of the openings thereof is entirely placed at the axially central relief 3′.

Still with reference to FIG. 1, each further series 9 of openings (even them shown only through the base module 11) is exemplarily positioned so that at least the 90% of an overall plant area of the respective openings thereof is placed at a respective further relief 3″.

Exemplarily each base module 11 has a first symmetry plane 100 parallel to an equatorial plane (not shown) of the tyre and a second symmetry plane 200 perpendicular to the equatorial plane of the tyre 1.

In the FIGS. 1 and 3-7 some embodiments of the base module 11 comprised in the respective noise-reducing sub-element 4′ are shown, in which the shape and/or the number of the openings of the first and of the second sets varies.

With reference to FIG. 1, the shown base module 11 comprises three circular openings belonging to the series 8 and four openings having elongated shape with a main dimension L, two by two belonging to the further series 9 of openings.

Consequently, the series 8 of openings comprises openings having the same shape and sizes and the further series 9 of openings comprise the same number of openings, with openings having the same shape, size and circumferential arrangement. Exemplarily the elongated shape of the openings 9′ of the further series 9 comprises two end portions 12 along the main dimension having a lobed shape and a central portion 13, of reduced size, which interconnects the two end portions 12.

Exemplarily the main dimension of each opening of the further series of openings 9 is parallel to the circumferential development of the tyre. Exemplarily, the diameter of the circular openings of the series 8 is equal to 3 cm, a length along the main dimension L of each opening of the further series 9 is equal to 7.5 cm, a radius of the lobed portions 12 is equal to 1.25 cm, a length of the central portion 13 is equal to 1.9 cm, and a width of the central portion 13 is equal to 1.25 cm. The noise-reducing sub-element 4′ has exemplary dimensions 22×14 cm.

Still with reference to the example of FIG. 1, a ratio between an overall volume of all the openings present on the sub-element, and an overall volume of the noise-reducing sub-element (defined by the envelope of the outer surface of the noise-reducing sub-element) is equal to about 0.23.

In FIGS. from 3 to 7 further embodiments of noise-reducing sub-elements are shown, each comprising a different base module 11. The base modules 11 differ from each other in the number and/or in the shape and/or size of the openings of the series 8 and/or of the further series 9 of openings. It is possible to observe that these openings can be circular or elongated (lobed or not) with a main dimension. In the case the openings have an elongated shape, the main dimension is preferably parallel to the circumferential development of the tyre (once the respective noise-reducing sub-element has been applied on the inner surface of the tyre itself).

1-17. (canceled)

18. A tyre comprising a tread band having one or more reliefs with circumferential development, and a noise-reducing element applied on an inner surface of the tyre and extending along at least half a circumferential development of the inner surface,
wherein the noise-reducing element comprises a series of radially through openings, wherein the series of openings extends along the circumferential development of the inner surface and wherein the series of openings is placed so that at least half of an overall plant area of the openings of the series of openings is placed at one relief of the one or more reliefs.

19. The tyre according to claim 18, wherein the noise-reducing element comprises one or more further series of radially through openings, wherein each further series of openings extends along the circumferential development of the inner surface and wherein at least one of the one or more further series of openings is placed so that at least half of an overall plant area of the openings of the at least one, or of each, further series of openings is placed at one respective further relief of the one or more reliefs.

20. The tyre according to claim 19, wherein the openings of the series of openings is placed so that at least 60% of the overall plant area of the openings of the series of openings is placed at one relief of the one or more reliefs, or the openings of the at least one, or of each, further series of openings is placed so that at least 60% of the overall plant area of the openings of the at least one, or of each, further series of openings is placed at one respective further relief of the one or more reliefs.

21. The tyre according to claim 19, wherein the noise reducing element extends along substantially the whole circumferential development of the inner surface, wherein the openings of the series of openings, or the openings of each of the one or more further series of openings, are arranged along substantially the whole circumferential development of the inner surface.

22. The tyre according to claim 19, wherein the series of openings comprises openings having a same shape and dimensions, wherein each of the one or more further series of openings comprises openings having the same shape and dimensions, wherein all the further series comprise a same number of openings, and wherein the openings of all the further series of openings have the same shape and dimensions and circumferential arrangement.

23. The tyre according to claim 19, wherein a boundary surface of each opening has a substantially radial development, wherein a section of each opening, perpendicular to an axis of development of the opening, is constant along the axis of development, and wherein the openings of the series of openings, the openings of each of the one or more further series of openings, or the openings of the series of openings and the openings of each of the one or more further series of openings, are substantially axially aligned with each other.

24. The tyre according to claim 19, wherein the noise-reducing element comprises at least two further series of radially through openings.

25. The tyre according to claim 19, wherein each opening of the one or more further series of openings has a section, perpendicular to an axis of development thereof, having an elongated shape with a main dimension, wherein the main dimension of the openings is substantially parallel to the circumferential development.

26. The tyre according to claim 25, wherein the main dimension of each opening has a length greater than or equal to 5 cm and less than or equal to 15 cm, and wherein the elongated shape comprises two end portions along the main dimension having a lobed shape and a central portion, of reduced size, which interconnects the two end portions.

27. The tyre according to claim 18, wherein the noise-reducing element comprises a plurality of noise-reducing sub-elements applied circumferentially in sequence along the circumferential development of the inner surface of the tyre.

28. The tyre according to claim 27, wherein the noise-reducing element, or each noise-reducing sub-element, is a parallelepiped in the non-deformed configuration, wherein the noise-reducing element comprises a sound-absorbing material and wherein the sound-absorbing material has a density ranging from about 5 kg/m³ to about 60 kg/m³.

29. The tyre according to claim 18, wherein the openings are arranged onto the noise-reducing element according to an ordered scheme, wherein the ordered scheme comprises a base module repeated along the circumferential development.

30. The tyre according to claim 29, wherein the base module has a first symmetry plane parallel to an equatorial plane of the tyre, and wherein the base module has a second symmetry plane perpendicular to an equatorial plane of the tyre.

31. The tyre according to claim 29, wherein the base module comprises a first set of openings belonging to the series of openings, wherein a number of openings of the first set is greater than or equal to one, and less than or equal to three, wherein the base module comprises a second set of openings for each of one or more further series of openings, and wherein a number of openings of each second set it is greater than or equal to two, and less than or equal to four.

32. The tyre according to claim 29, wherein the noise-reducing element comprises a plurality of noise-reducing sub-elements applied circumferentially in sequence along the circumferential development of the inner surface of the tyre, and wherein each noise-reducing sub-element comprises one base module.

33. The tyre according to claim 18, wherein each opening of the series of openings has a section, perpendicular to an axis of development thereof, of circular shape having a diameter, wherein the diameter is greater than or equal to 2 cm, and less than or equal to 6 cm.

34. The tyre according to claim 18, wherein a ratio between an overall volume of all the openings present on the noise-reducing element, and an overall volume of the noise-reducing element, is greater than or equal to 0.1, and less than or equal to 0.4.
